(19) United States
(12) Patent Application Publication
(10) Pub. No.: US 2024/0054813 A1
(43) Pub. Date: Feb. 15, 2024

(54) INFORMATION GENERATION DEVICE, INFORMATION GENERATION SYSTEM, INFORMATION GENERATION METHOD, AND RECORDING MEDIUM

(71) Applicant: NEC Corporation, Tokyo (JP)

(72) Inventors: Masanori KOBAYASHI, Tokyo (JP); Akihiko ICHIKAWA, Tokyo (JP)

(73) Assignee: NEC Corporation, Tokyo (JP)

(21) Appl. No.: 18/383,491

(22) Filed: Oct. 25, 2023

Related U.S. Application Data
(63) Continuation of application No. 17/799,997, filed on Aug. 16, 2022.

(51) Int. Cl. G06V 40/16; G06Q 50/14

(52) U.S. Cl. CPC G06V 40/172; G06Q 50/14

(57) ABSTRACT

An information generation device includes a detection information acquisition unit that acquires detection information in which biometric information detected at a tourism spot is associated with a place at which the biometric information is detected, a search unit that searches a first database in which identification information, in which personal information of a person is associated with the biometric information, is accumulated to identify the personal information of the person from which the detection information originates using the biometric information included in the detection information, and a behavior information generation unit that generates behavior information in which the personal information of the person from which the detection information originates is associated with the place at which the biometric information of the person from which the detection information originates is detected, and records the generated behavior information in a second database.

This application is a Continuation of U.S. application Ser. No. 17/799,997 filed on Aug. 16, 2022, which is a National Stage Entry of PCT/JP2020/009916 filed on Mar. 9, 2020, the contents of all of which are incorporated herein by reference, in their entirety.

### TECHNICAL FIELD

The present invention relates to an information generation device and the like that generate behavior information based on behavior of a person.

### BACKGROUND ART

Tourism is an important industry for countries. If a country increases the satisfaction of tourists (also referred to as travelers), the tourists get a good impression of the country, from which various merits can be expected. In order to increase the satisfaction of the tourists, it is effective to analyze statistical data such as what place the tourists prefer to visit. In general, such statistical data is collected by conducting questionnaires or the like with respect to tourists who have visited each tourism spot.

PTL 1 discloses a technique for improving customer satisfaction (CS) by collecting position information of tourists. In the method according to PTL 1, information on a position that a tourist has passed is collected at a tourism spot, and the collected tourist route is accumulated as data. Then, in the method according to PTL 1, a tourist route is proposed based on the accumulated data.

### CITATION LIST

### [Patent Literature]

[PTL 1] JP 2014-174907 A

### SUMMARY OF INVENTION

### Technical Problem

In the method according to PTL 1, identification information for identifying a tourist is recorded in an article carried by the tourist at an accommodation or the like of the tourist. Then, in the method according to PTL 1, a tour route of the tourist is collected in such a manner that the tourist presents the identification information recorded in the article at a tourism spot around the tourist's accommodation or the like.

In the method according to PTL 1, since a tourist has to carry an article in which identification information is recorded, when the tourist does not carry the article, a tour route of the tourist cannot be collected. In addition, in the method according to PTL 1, since an individual tourist is identified based on identification information recorded in an article when a tour route of the tourist is collected, in a case where a certain tourist behaves in a state where the article is carried by another tourist, an accurate tour route cannot be collected. That is, the method according to PTL 1 is not capable of generating accurate statistical data about tourists.

An object of the present invention is to provide an information generation device and the like capable of generating accurate statistical data about tourists.

### Solution to Problem

According to an aspect of the present invention, an information generation device includes a detection information acquisition unit that acquires detection information in which biometric information detected at a tourism spot is associated with a place at which the biometric information is detected, a search unit that searches a first database in which identification information, in which personal information of a person is associated with the biometric information, is accumulated to identify the personal information of the person from which the detection information originates using the biometric information included in the detection information, and a behavior information generation unit that generates behavior information in which the personal information of the person from which the detection information originates is associated with the place at which the biometric information of the person from which the detection information originates is detected, and records the generated behavior information in a second database.

According to an aspect of the present invention, an information generation method performed by a computer includes acquiring detection information in which biometric information detected at a tourism spot is associated with a place at which the biometric information is detected, searching a first database in which identification information, in which personal information of a person is associated with the biometric information, is accumulated to identify the person from which the detection information originates using the biometric information included in the detection information, and generating behavior information in which the personal information of the person from which the detection information originates is associated with the place and the time at which the biometric information of the person from which the detection information originates is detected, and recording the generated behavior information in a second database.

According to another aspect of the present invention, a program causes a computer to execute processing of acquiring detection information in which biometric information detected at a tourism spot is associated with a place at which the biometric information is detected, searching a first database in which identification information, in which personal information of a person is associated with the biometric information, is accumulated to identify the person from which the detection information originates using the biometric information included in the detection information, and generating behavior information in which the personal information of the person from which the detection information originates is associated with the place and the time at which the biometric information of the person from which the detection information originates is detected, and recording the generated behavior information in a second database.

### Advantageous Effects of Invention

According to the present invention, it is possible to provide an information generation device and the like capable of generating accurate statistical data about tourists.

### BRIEF DESCRIPTION OF DRAWINGS

FIG. 1 is a conceptual diagram illustrating an example of an information generation system according to a first example embodiment.

FIG. 2 is a conceptual diagram illustrating an example of identification information acquired from a first database by an information generation device of the information generation system according to the first example embodiment.

FIG. 3 is a conceptual diagram illustrating an example of detection information acquired from a detection terminal by the information generation device of the information generation system according to the first example embodiment.

FIG. 4 is a conceptual diagram illustrating an example of behavior information generated by the information generation device of the information generation system according to the first example embodiment.

FIG. 5 is a block diagram illustrating an example of a configuration of the information generation device of the information generation system according to the first example embodiment.

FIG. 6 is a table illustrating an example of behavior information accumulated by the information generation device of the information generation system according to the first example embodiment.

FIG. 7 is a conceptual diagram illustrating an example of behavior history information generated by the information generation device of the information generation system according to the first example embodiment.

FIG. 8 is a table illustrating another example of behavior history information generated by the information generation device of the information generation system according to the first example embodiment.

FIG. 9 is a table illustrating another example of behavior history information generated by the information generation device of the information generation system according to the first example embodiment.

FIG. 10 is a flowchart for explaining an example of an operation of the information generation device of the information generation system according to the first example embodiment.

FIG. 11 is a block diagram illustrating an example of a configuration of an information generation device of an information generation system according to a second example embodiment.

FIG. 12 is a table illustrating an example of rank information generated by the information generation device of the information generation system according to the second example embodiment.

FIG. 13 is a table illustrating another example of rank information generated by the information generation device of the information generation system according to the second example embodiment.

FIG. 14 is a table illustrating still another example of rank information generated by the information generation device of the information generation system according to the second example embodiment.

FIG. 15 is a conceptual diagram illustrating an example in which recommendation information based on the rank information generated by the information generation device of the information generation system according to the second example embodiment is displayed on a screen of a display device.

FIG. 16 is a conceptual diagram illustrating an example of an information generation system according to a third example embodiment.

FIG. 17 is a block diagram illustrating an example of a configuration of an information generation device of the information generation system according to the third example embodiment.

FIG. 18 is a conceptual diagram illustrating an example of detection information acquired from a detection terminal by the information generation device of the information generation system according to the third example embodiment.

FIG. 19 is a table illustrating an example of behavior information generated by the information generation device of the information generation system according to the third example embodiment.

FIG. 20 is a table illustrating an example of behavior information accumulated by the information generation device of the information generation system according to the third example embodiment.

FIG. 21 is a conceptual diagram illustrating an example of behavior history information generated by the information generation device of the information generation system according to the third example embodiment.

FIG. 22 is a table illustrating another example of behavior history information generated by the information generation device of the information generation system according to the third example embodiment.

FIG. 23 is a table illustrating still another example of behavior history information generated by the information generation device of the information generation system according to the third example embodiment.

FIG. 24 is a conceptual diagram illustrating an example in which recommendation information generated by the information generation device of the information generation system according to the third example embodiment is displayed on a screen of a display device.

FIG. 25 is a conceptual diagram illustrating another example in which recommendation information generated by the information generation device of the information generation system according to the third example embodiment is displayed on a screen of a display device.

FIG. 26 is a block diagram illustrating an example of a configuration of an information generation device of an information generation system according to a fourth example embodiment.

FIG. 27 is a block diagram illustrating an example of a hardware configuration for achieving the information generation device according to each of the example embodiments.

### EXAMPLE EMBODIMENT

Hereinafter, example embodiments of the present invention will be described with reference to the drawings. However, it should be noted that the example embodiments to be described below are limited to be technically preferable in carrying out the present invention, but the scope of the invention is not limited to the following example embodiments. In all the drawings used to describe the following example embodiments, the same reference numerals are given to the same parts unless there is a particular reason. Further, in the following example embodiments, the description of the same configurations and operations may not be repeated. In addition, a direction of an arrow in the drawings is exemplary and does not limit a direction of a signal between blocks.

### First Example Embodiment

First, an information generation system according to a first example embodiment will be described with reference to the drawings. The information generation system according to the present example embodiment detects a tourist (hereinafter, referred to as a traveler) based on biometric information detected at a tourism spot or the like by using personal information associated with the biometric information of the traveler. The information generation system according to the present example embodiment generates behavior information of the detected traveler and accumulates the generated behavior information in a database.

(Configuration)

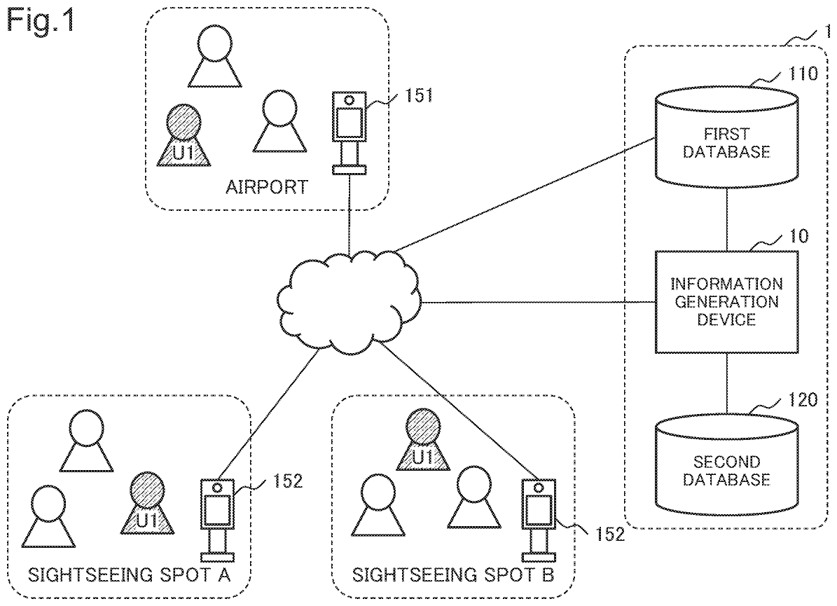

FIG. 1 is a conceptual diagram for explaining an information generation system 1 according to the present example embodiment. The information generation system 1 includes an information generation device 10, a first database 110, and a second database 120. FIG. 1 illustrates an example in which a registration terminal 151 for registering identification information of a traveler is installed at an airport or the like, and a detection terminal 152 for detecting a traveler is installed at a tourism spot.

The identification information of the traveler is accumulated in the first database 110. For example, the identification information of the traveler is information in which biometric information (feature amount) extracted from a face of a traveler is associated with personal information of the traveler. As an example, identification information registered via the registration terminal 151 is accumulated in the first database 110. As another example, identification information input in accordance with a dedicated form prepared on a website accessible via the Internet is registered in the first database 110. In order to protect personal information, the information generation system 1 uses personal information that a traveler has agreed to provide in advance.

The identification information registered in the first database 110 may be dedicated data used only by the information generation system 1, or may be general-purpose data registered in an existing database by a general-purpose system. When the general-purpose data registered in the existing database is used, the general-purpose data may be used based on a contract for usage or the like made in advance.

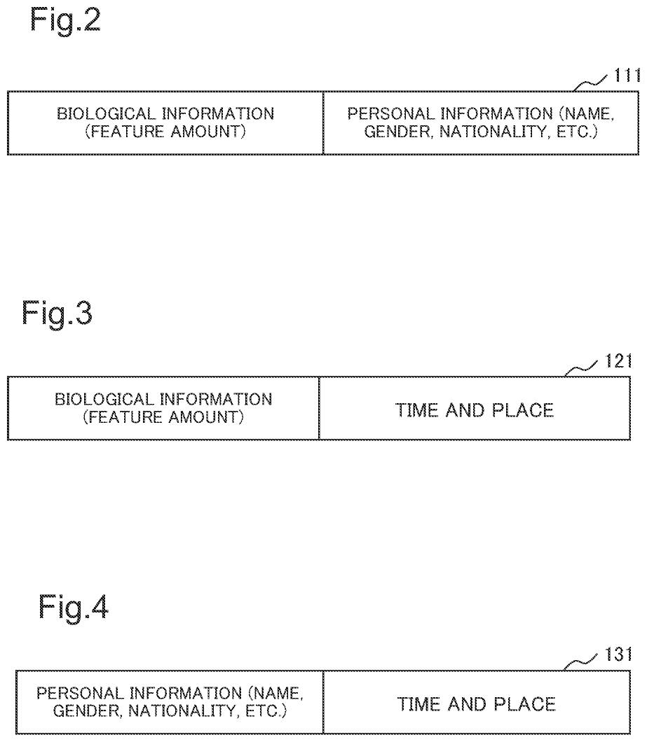

FIG. 2 is a conceptual diagram illustrating an example (identification information 111) of the identification information accumulated in the first database 110. The identification information 111 is information in which biometric information (feature amount) and personal information of a traveler are associated with each other. For example, the identification information 111 includes information on the name, gender, nationality, etc. of the traveler.

The registration terminal 151 is installed at an airport or the like. The registration terminal 151 registers the personal information of the traveler based on information and documents issued by a public institution. For example, the registration terminal 151 registers the personal information described in the passport of the traveler. Generally, a face (biometric information), a nationality, and a gender are registered in association with each other in a passport. For example, the registration terminal 151 has a scan function to read a traveler's passport, a function to register personal information via a traveler' mobile terminal, or the like. The registration terminal 151 may acquire face data of a traveler by photographing a face of the traveler. The registration terminal 151 extracts biometric information from the generated face data. The registration terminal 151 extracts personal information of a traveler described in a passport by reading the passport of the traveler. For example, the registration terminal 151 extracts attribute data (also referred to as passport information) such as name, nationality, and gender described in the passport. For example, when photographing a face of a traveler, the registration terminal 151 reads attribute data (passport information) described in a passport of the traveler, such as name, nationality, and gender. The registration terminal 151 accumulates identification information, in which the biometric information and the personal information of the traveler are associated with each other, in first database 110. The identification information registered in the registration terminal 151 may include attribute data other than name, nationality, and gender. For example, the identification information may include information about the traveler such as age, date of birth, travel history, place of residence, passport number or issue date of passport, and passport issuing office. For example, the biometric information of the traveler may be extracted from the photograph of the passport.

The information generation device 10 acquires detection information from the detection terminal 152 installed at a tourism spot or the like. The detection information is information in which biometric information extracted from a face image captured by the detection terminal 152 is associated with a time and a place at which the face image is captured. The place included in the detection information may be position information of the detection terminal 152, or may be a name of a tourism spot where the detection terminal 152 is installed, or the like. Alternatively, the detection information may be a name of a store, a shrine or a temple, a park, a facility, or the like at which the detection terminal 152 is installed.

The detection terminal 152 may be a dedicated terminal or a general-purpose terminal. For example, the detection terminal 152 functions to photograph a traveler who has visited a tourism spot, generate detection information by using a captured face image, and transmitting the generated detection information to the information generation device 10. The detection terminal 152 may include a point of sale (POS) terminal used for payment based on face authentication, for example, as will be described in a third example embodiment later. For example, the detection information may be extracted from image data obtained by capturing an image using a monitoring camera or a digital signage. In a case where image data obtained by capturing an image using a monitoring camera or a digital signage installed, for example, at a tourism spot can be used, biometric information may be extracted from the image data obtained by capturing the image using the monitoring camera or the digital signage. In addition, the information generation device 10 may acquire the image data obtained by capturing the image using the monitoring camera or the digital signage, and extract biometric information from the acquired image data.

FIG. 3 is a conceptual diagram illustrating an example (detection information 121) of detection information acquired by the information generation device 10. The detection information 121 is information in which the biometric information (feature amount) of the traveler is associated with a time and a place at which a face image or the like, from which the biometric information originates, is acquired.

When acquiring the detection information, the information generation device 10 retrieves personal information corresponding to the biometric information included in the detection information, referring to the first database 110. For example, the information generation device 10 searches the first database 110 in a one-to-N collation manner. The information generation device 10 generates behavior information in which the retrieved personal information is associated with the place and the time included in the detection information. That is, the behavior information is information indicating what place a certain traveler visited at what time. The information generation device 10 accumulates the generated behavior information in the second database 120.

FIG. 4 is a conceptual diagram illustrating an example (behavior information 131) of behavior information generated by the information generation device 10. The behavior information 131 is information in which personal information of a traveler is associated with a time and a place at which the traveler visited a tourism spot or the like. The behavior information generated by the information generation device 10 is accumulated in the second database 120. Behavior information of a plurality of travelers generated by the information generation system 1 is accumulated in the second database 120. The behavior information accumulated in the second database 120 may be configured to be able to be referred to by a system other than the information generation system 1 based on a contract for usage or the like made in advance.

According to the present example embodiment, it is possible to track a traveler based on biometric information of the traveler detected at a tourism spot, and accordingly, it is possible to generate accurate statistical data about the traveler.

(Information Generation Device)

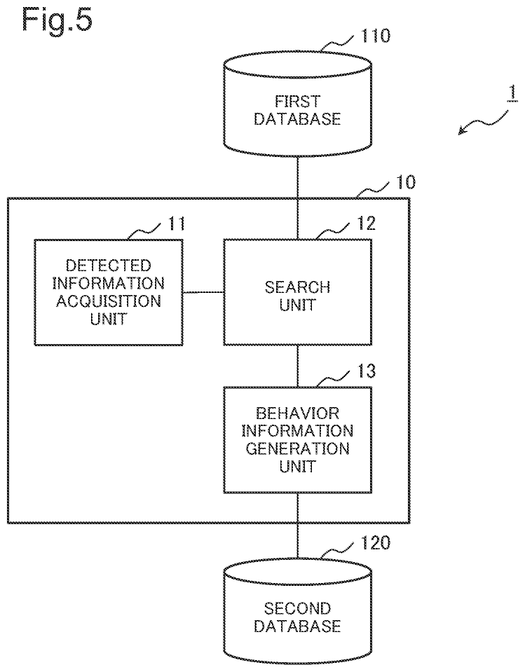

Next, a detailed configuration of the information generation device will be described with reference to the drawings. FIG. 5 is a block diagram illustrating an example of a configuration of the information generation device 10 together with the first database 110 and the second database 120. The information generation device 10 includes a detection information acquisition unit 11, a search unit 12, and a behavior information generation unit 13. Note that the information generation device 10 of FIG. 5 is provided according to one aspect of the present example embodiment, and the configuration of the information generation device 10 according to the present example embodiment is not limited to the configuration of FIG. 5.

The detection information acquisition unit 11 acquires detection information of a traveler via a network such as the Internet. For example, the detection information acquisition unit 11 acquires detection information detected by the detection terminal 152 installed at a tourism spot or the like. The detection information acquisition unit 11 outputs the acquired detection information to the search unit 12. For example, in a case where biometric information included in the detection information is image data, the detection information acquisition unit 11 may extract a feature amount from the image data, such that the extracted feature amount is used as the biometric information.

The search unit 12 acquires the detection information from the detection information acquisition unit 11. When acquiring the detection information, the search unit 12 retrieves personal information corresponding to the biometric information included in the detection information, referring to the first database 110. For example, the search unit 12 searches the first database 110 in a one-to-N collation manner. The search unit 12 outputs the retrieved personal information to the behavior information generation unit 13.

The behavior information generation unit 13 acquires the personal information retrieved by the search unit 12. The behavior information generation unit 13 generates behavior information in which the personal information retrieved by the search unit 12 is associated with the place and the time included in the detection information. The behavior information generation unit 13 accumulates the generated behavior information in the second database 120.

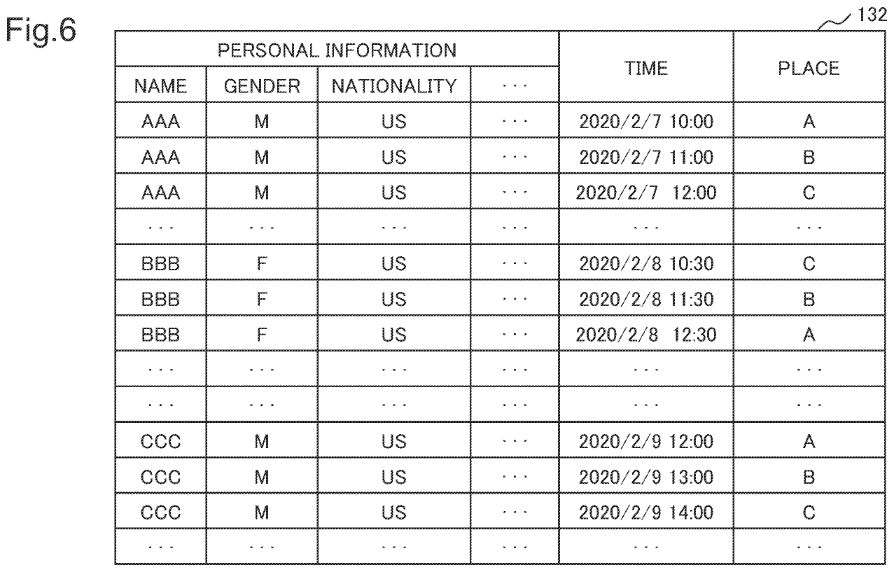

FIG. 6 is a table illustrating an example (behavior information 132) of behavior information accumulated in the second database 120 by the behavior information generation unit 13. The behavior information 132 includes information in which personal information including names, genders, nationalities, etc. of a plurality of travelers is associated with times and places at which the plurality of travelers were detected at tourism spots. For example, concerning a traveler whose name is AAA, the gender is male M and the nationality is the United States US. On Feb. 7, 2020, AAA was detected at tourism spot A at 10:00, at tourism spot B at 11:00, and at tourism spot C at 12:00.

For example, the behavior information generation unit 13 generates behavior history information including a behavior history of a traveler by using the behavior information accumulated in the second database 120. The behavior history information is information in which personal information of a traveler is associated with a behavior history of the traveler. For example, the behavior information generation unit 13 generates behavior history information for each traveler. For example, the behavior information generation unit 13 generates behavior history information at a certain timing such as a timing when a request is received from a user who uses the second database 120, a timing when a date changes, or a timing when a traveler goes home.

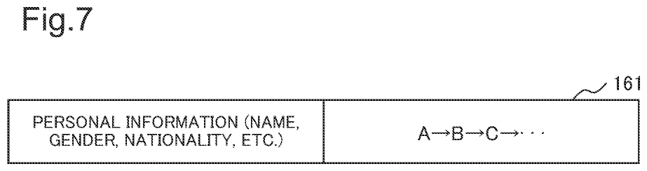

FIG. 7 illustrates an example (behavior history information 161) of a behavior history generated by the behavior information generation unit 13 using the behavior information accumulated in the second database 120. For example, the behavior information generation unit 13 determines that “AAA visited tourism spots A, B, and C in this order on Feb. 7, 2020”, referring to times included in the behavior information 132 of FIG. 6. Based on the determination result, the behavior information generation unit 13 generates behavior history information 161 in which the tourism spots visited by the traveler are listed in time-series order.

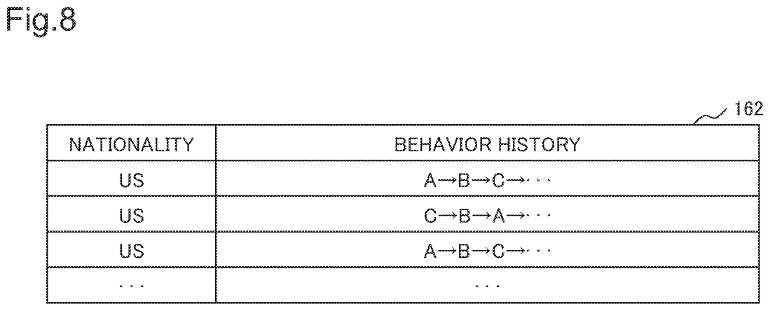

FIG. 8 is a table illustrating an example (behavior history information 162) of behavior history information in which the behavior history information generated based on the behavior information (behavior information 132) accumulated in the second database 120 is sorted by nationality, which is attribute data. The behavior history information 162 is an example in which behavior history information of travelers whose nationality is US is sorted out among the attribute data included in the personal information.

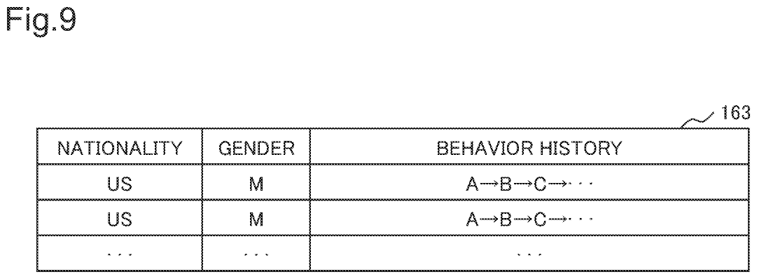

FIG. 9 is a table illustrating an example (behavior history information 163) of behavior history information in which the behavior history information generated based on the behavior information (behavior information 132) accumulated in the second database 120 is sorted by nationality and gender, which are attribute data. The behavior history information 163 is an example in which behavior history information of travelers whose nationality is the United States (US) and gender is male (M) is sorted out among the attribute data included in the personal information.

(Operation)

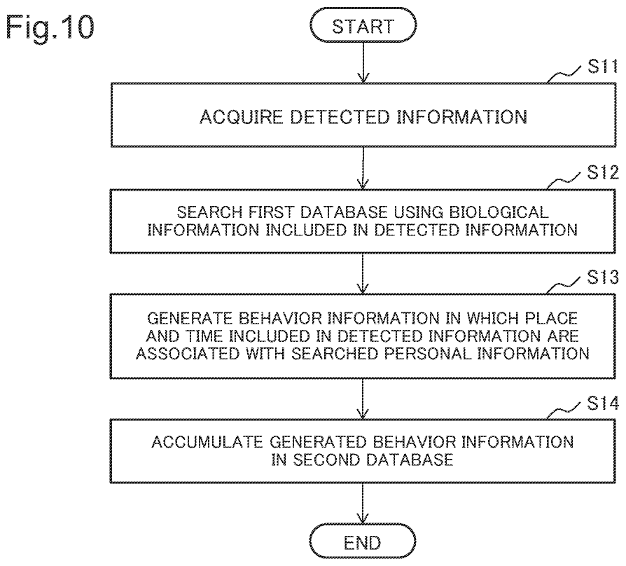

Next, an example of an operation of the information generation device 10 according to the present example embodiment will be described with reference to the drawings. FIG. 10 is a flowchart for explaining an example of the operation of the information generation device 10.

In FIG. 10, first, the information generation device 10 acquires detection information from the detection terminal 152 installed at a tourism spot (step S11).

Next, the information generation device 10 searches the first database 110 using biometric information included in the acquired detection information (step S12).

Next, the information generation device 10 generates behavior information by associating a place and a time included in the detection information with personal information retrieved from the first database 110 (step S13).

Next, the information generation device 10 accumulates the generated behavior information in the second database 120 (step S14).

As described above, the information generation device according to the present example embodiment includes a detection information acquisition unit, a search unit, and a behavior information generation unit. The detection information acquisition unit acquires detection information in which biometric information detected at a tourism spot is associated with a place and a time at which the biometric information is detected. The search unit searches a first database in which identification information, in which personal information of the traveler is associated with the biometric information, is accumulated to identify the traveler from which the detection information originates using the biometric information included in the detection information. The behavior information generation unit generates behavior information in which the personal information of the traveler from which the detection information originates is associated with the place and the time at which the biometric information of the traveler from which the detection information originates is detected, and records the generated behavior information in a second database.

For example, the personal information includes attribute data on at least one of nationality and gender of the traveler. For example, the biometric information extracted from face data generated by photographing a face of the traveler, the nationality of the traveler, and the gender of the traveler are registered in the first database in association with each other. For example, when the face of the traveler is photographed, the nationality and the gender of the traveler read from a passport of the traveler are registered in the first database in association with the biometric information. For example, the behavior information generation unit generates behavior history information in which a behavior history, in which the behavior information of the traveler is listed in time series, is associated with the personal information.

An information generation system according to one aspect of the present example embodiment includes an information generation device, a first database, and a second database. For example, the information generation system according to one aspect of the present example embodiment includes a detection information generation device that detects biometric information of a traveler, generates detection information by associating a place and a time at which the biometric information of the traveler is detected with the biometric information of the traveler, and outputs the generated detection information to the information generation device. For example, the information generation system according to one aspect of the present example embodiment includes an identification information generation device that acquires personal information and biometric information of a traveler, generates identification information by associating the personal information and the biometric information of the traveler with each other, and registers the generated identification information in the first database.

In one aspect of the present example embodiment, the behavior information generation unit generates behavior history information in which a behavior history, in which behavior information of the traveler is listed in time series, is associated with the personal information. In one aspect of the present example embodiment, the behavior information generation unit sorts the behavior history information using at least one piece of the attribute data as a key.

According to the present example embodiment, it is possible to track a traveler based on biometric information of the traveler obtained by capturing an image at a tourism spot, and accordingly, it is possible to generate accurate statistical data about the traveler.

For example, a traveler who travels by airplane via a hub airport such as Narita Airport may wait at that place for several hours to transit an airplane at the hub airport. According to the present example embodiment, it is possible to generate information for presenting a transit tour of a tourism spot around the hub airport in accordance with such a waiting time.

In addition, according to the present example embodiment, it is possible to generate behavior history information of a traveler including various kinds of attribute data by individually identifying the traveler who has visited tourism spots and accumulating information. The behavior history information of the traveler may also serve as reference information for creating a tour such as a transit tour, and may also serve as an information source of statistical data compiled by the Ministry of Tourism. In addition, the technique according to the present example embodiment can also be applied to generate behavior history information for retail stores such as duty-free stores where many travelers visit, as well as tourism spots. For example, the technique according to the present example embodiment can also be applied to generate behavior history information regarding behavior of a traveler inside a retail store and behavior of a traveler across a plurality of stores.

### Second Example Embodiment

Next, an information generation system according to a second example embodiment will be described with reference to the drawings. An information generation device according to the present example embodiment is different from that in the first example embodiment in that rank information obtained by ranking behavior information of a plurality of travelers is generated by using behavior data accumulated in the second database.

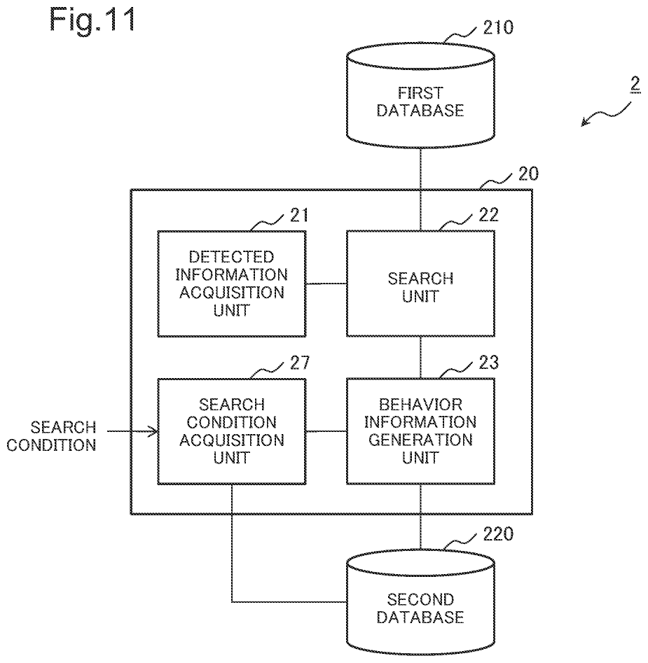

FIG. 11 is a block diagram illustrating an example of a configuration of an information generation system 2 according to the present example embodiment. The information generation system 2 includes an information generation device 20, a first database 210, and a second database 220. The information generation device 20 includes a detection information acquisition unit 21, a search unit 22, a behavior information generation unit 23, and a search condition acquisition unit 27. The first database 210, the second database 220, the detection information acquisition unit 21, the search unit 22, and the behavior information generation unit 23 are similar to the corresponding configurations in the first example embodiment, and thus, detailed description thereof will be omitted. The second example embodiment will be described below, focused on the difference from the first example embodiment.

The search condition acquisition unit 27 acquires a search condition input via an input device (not illustrated). The search condition relates to a condition for ranking the behavior information. For example, the search condition is attribute data included in the personal information, a place or time at which tourist data is acquired, or the like. The search condition acquisition unit 27 outputs the acquired search condition to the behavior information generation unit 23.

The behavior information generation unit 23 acquires the search condition from the search condition acquisition unit 27. The behavior information generation unit 23 searches the second database 220 based on the acquired search condition, and acquires behavior information satisfying the search condition. The behavior information generation unit 23 ranks the behavior information satisfying the search condition. The behavior information generation unit 23 outputs rank information, which is a ranking result, to a counting information input source.

For example, the behavior information generation unit 23 ranks the behavior information satisfying the search condition depending on frequency. For example, in a case a tour is planned to travel around popular tourism spots, the behavior information generation unit 23 ranks the behavior information satisfying the search condition in such a manner that pieces of behavior information many travelers have are ranked high. For example, in a case where a tour is planned to travel around unoccupied tourism spots, the behavior information generation unit 23 ranks the behavior information satisfying the search condition in such a manner that pieces of behavior information a few travelers have are ranked high.

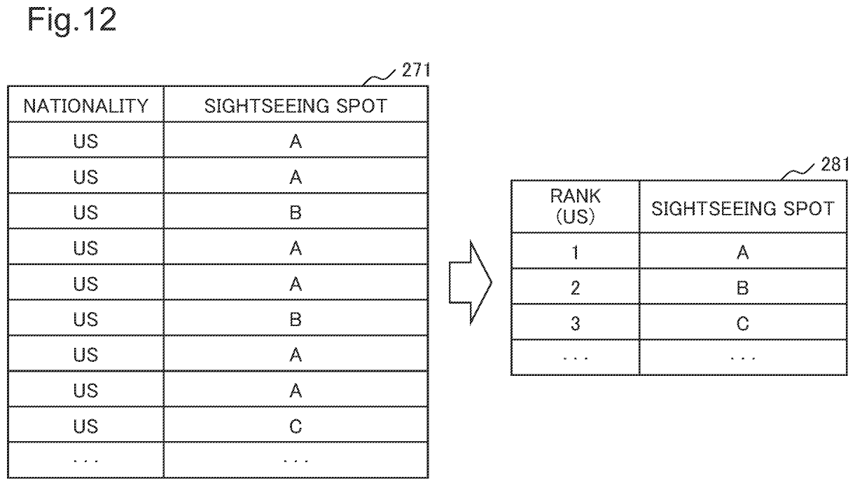

FIG. 12 is a conceptual diagram for explaining an example in which behavior information is sorted by nationality and the sorted-out behavior information is ranked. In the example of FIG. 12, first, the behavior information generation unit 23 generates sorted-out information 271 by sorting tourism spots using nationality as a key. Then, the behavior information generation unit 23 generates rank information 281 depending on the number of travelers who have visited each of the tourism spots included in the sorted-out information 271. Referring to the rank information 281, tourism spot A is ranked first, tourism spot B is ranked second, and tourism spot C is ranked third. Note that a smaller rank value indicates a higher rank.

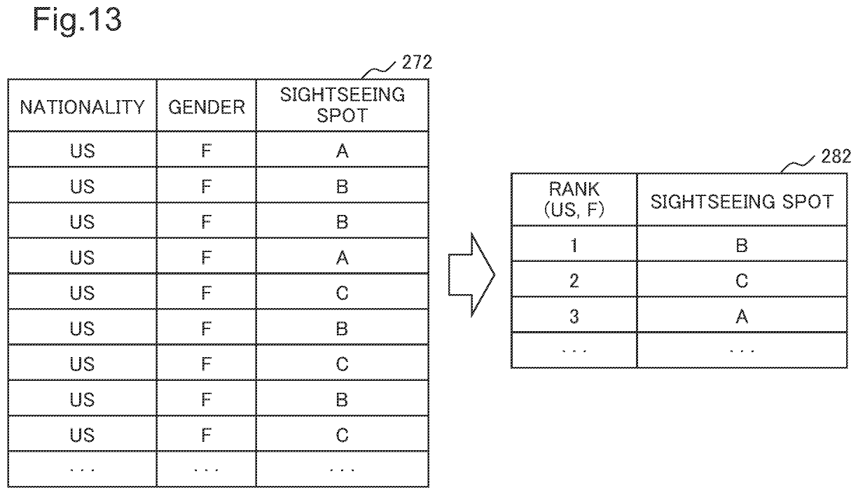

FIG. 13 is a conceptual diagram for explaining an example in which behavior information is sorted by nationality and gender, and the sorted-out behavior information is ranked. In the example of FIG. 13, first, the behavior information generation unit 23 generates sorted-out information 272 by sorting tourism spots using nationality and gender as keys. Then, the behavior information generation unit 23 generates rank information 282 depending on the number of travelers who have visited each of the tourism spots included in the sorted-out information 272. Referring to the rank information 282, tourism spot B is ranked first, tourism spot C is ranked second, and tourism spot A is ranked third. As in the example of FIG. 13, by sorting using two or more attribute data, rank information different from the case of sorting by one attribute data can be obtained.

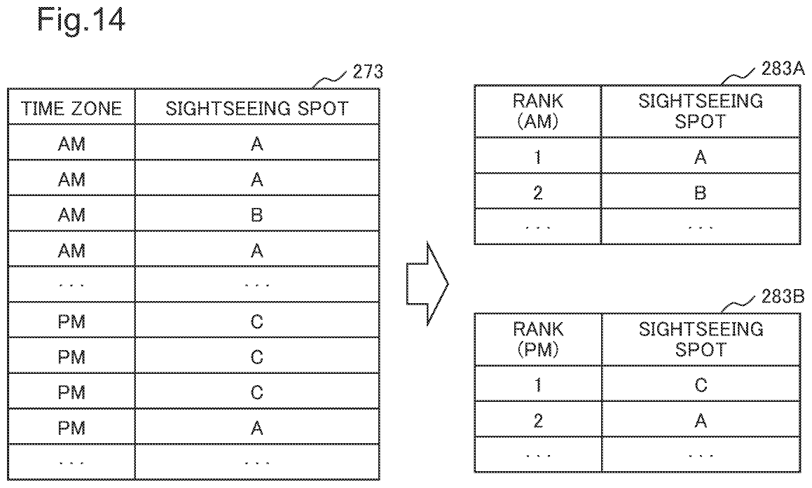

FIG. 14 is a conceptual diagram for explaining an example in which behavior information is sorted by time zone and the sorted-out behavior information is ranked. In the example of FIG. 14, first, the behavior information generation unit 23 generates sorted-out information 273 by sorting tourism spots using time zone (AM or PM) as a key. Then, the behavior information generation unit 23 generates rank information 283A and rank information 283B depending on the number of travelers who have visited each of the tourism spots included in the sorted-out information 273. The rank information 283A indicates ranking regarding the number of travelers who have visited each of the tourism spot in time zone AM. The rank information 283B indicates ranking regarding the number of travelers who have visited each of the tourism spot in time zone PM. Referring to the rank information 283A, tourism spot A is ranked first, and tourism spot B is ranked second. On the other hand, referring to the rank information 283B, tourism spot B is ranked first, and tourism spot A is ranked second. As in the example of FIG. 14, if the behavior information is sorted by time zone, the time zone in which the travelers visit can be specified, so that a plan based on time zone can be prepared. For example, not only a time zone such as AM or PM, but also a time zone including a specific time or a time zone desired by a traveler may be used as the search condition.

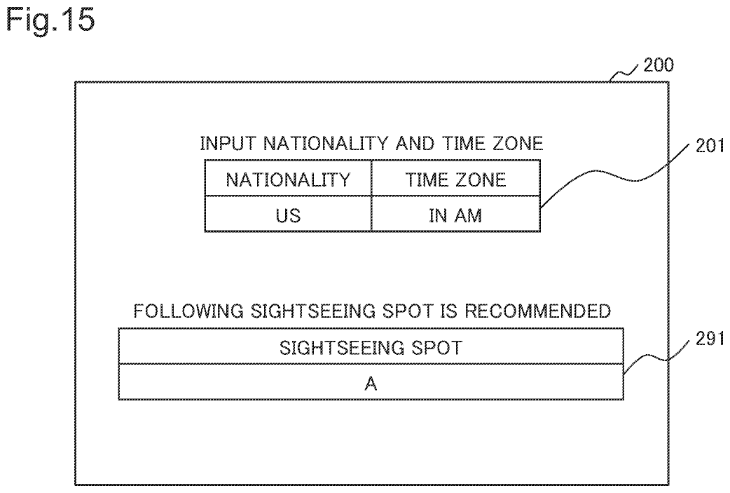

FIG. 15 is a conceptual diagram illustrating an example (recommendation information 291) of recommendation information including a recommended plan based on rank information generated by the behavior information generation unit 23. FIG. 15 is an example in which the recommendation information 291 based on counting information 201 is displayed on a screen of a display device 200. For example, the behavior information generation unit 23 generates recommendation information for recommending, to a traveler, a highest-ranked tourism spot included in rank information sorted out in accordance with the nationality of the traveler from rank information generated by nationality. For example, the behavior information generation unit 23 generates recommendation information for recommending, to a traveler, a highest-ranked tourism spot included in rank information sorted out in accordance with the time zone that matches a free time of the traveler from rank information generated by time zone. For example, in a field for inputting search conditions 201, a nationality of a traveler and a time zone are input. For example, the information generation device 20 causes the display device 200 to display the recommendation information 291 including a tourism spot ranked first among tourism spots visited by travelers having the input nationality in the input time zone.

In the example of FIG. 15, the information generation device 20 presents the recommendation information 291 including tourism spot A, based on the input counting information 201.

As described above, the information generation device according to the present example embodiment includes a search condition acquisition unit that acquires a search condition for searching the second database. The behavior information generation unit searches the second database according to the search condition, and generates rank information with respect to places included in the behavior information satisfying the search condition.

In one aspect of the present example embodiment, based on the rank information, the behavior information generation unit generates recommendation information for recommending at least one among the places included in the behavior information satisfying the search condition.

According to the present example embodiment, accurate statistical data about travelers can be ranked. By using the rank information, it is possible to present recommendation information according to an attribute of a traveler or a time desired by a traveler.

For example, according to the present example embodiment, it is possible to generate recommendation information suitable for an attribute such as nationality, gender, or age according to a time zone, for example, recommending tourism spot A if the time zone is AM, or recommending tourism spot B if the time zone is PM. According to the present example embodiment, it is also possible to generate recommendation information suitable for a situation, such as how crowded a tourism spot is, by matching the real-time situation of the tourism spot. Furthermore, according to the present example embodiment, it is possible to recommend, to a traveler who has a free time of a few hours at a transit airport, a transit tour to travel around tourism spots around the airport during the free time.

### Third Example Embodiment

Next, an information generation system according to a third example embodiment will be described with reference to the drawings. The information generation system according to the present example embodiment is different from those in the first and second example embodiments in that payment data including an amount paid by a traveler at a facility in a tourism spot is included in the detection information and the behavior information.

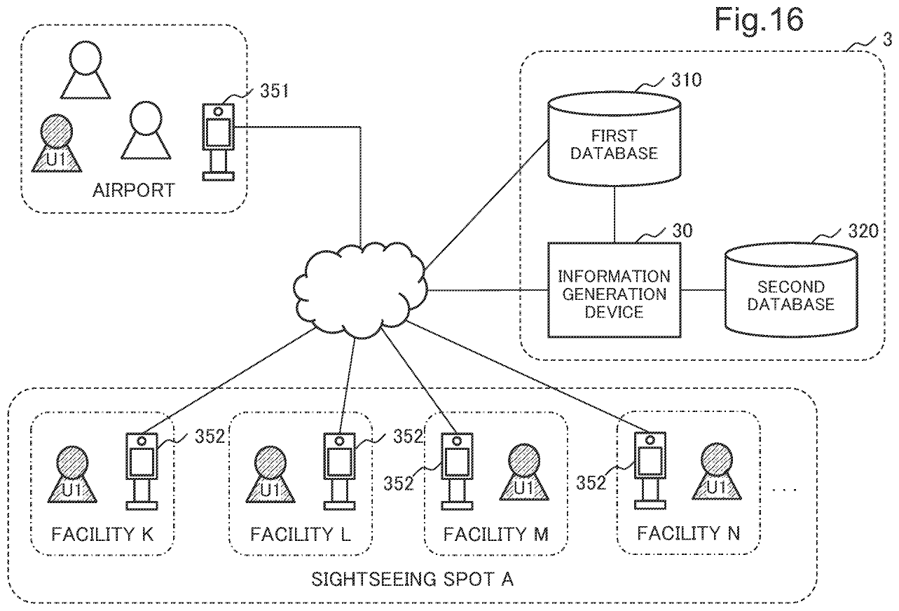

FIG. 16 is a conceptual diagram for explaining an information generation system 3 according to the present example embodiment. The information generation system 3 includes an information generation device 30, a first database 310, and a second database 320. The first database 310 and the second database 320 are similar to the corresponding configurations in the first example embodiment, and thus, detailed description thereof will be omitted. FIG. 16 illustrates an example in which a registration terminal 351 for registering identification information of a traveler is installed at an airport or the like, and a detection terminal 352 for detecting a traveler is installed at each of facilities (facility K, facility L, facility M, and facility N) in tourism spot A. The facilities may be located within one tourism spot, or may be dispersed in a plurality of tourism spots.

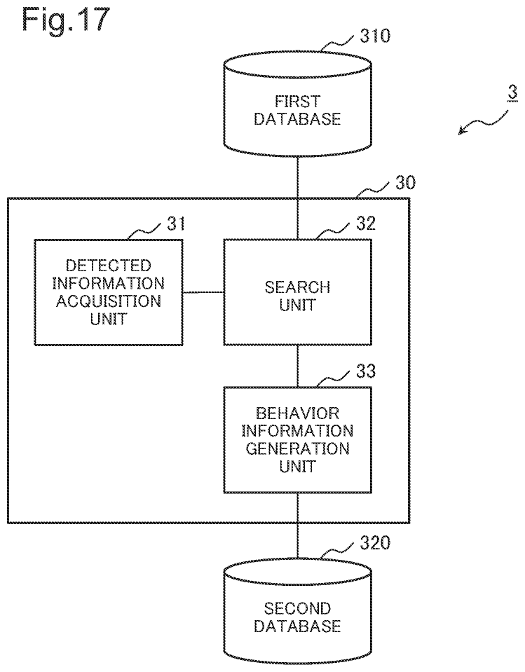

FIG. 17 is a block diagram illustrating an example of a configuration of the information generation device 30. The information generation device 30 includes a detection information acquisition unit 31, a search unit 32, and a behavior information generation unit 33.

The detection information acquisition unit 31 acquires detection information of a traveler via a network such as the Internet. For example, the detection information acquisition unit 31 acquires detection information detected by the detection terminal 352 installed at a tourism spot or the like. The detection information acquisition unit 31 outputs the acquired detection information to the search unit 32. For example, in a case where biometric information included in the detection information is image data, the detection information acquisition unit 31 may extract a feature amount from the image data, such that the extracted feature amount is used as the biometric information.

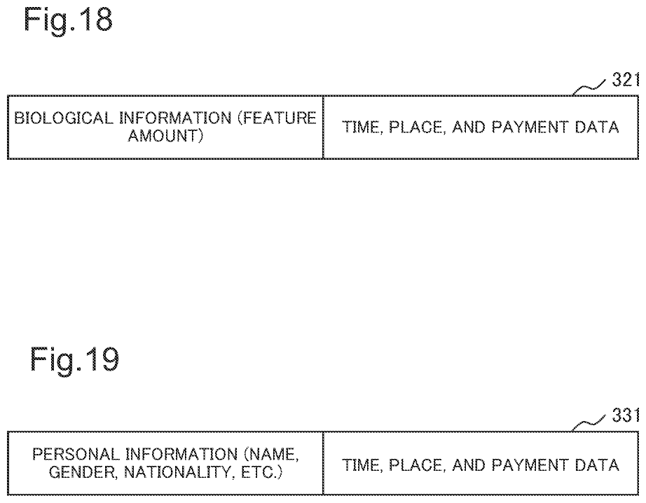

FIG. 18 is a conceptual diagram illustrating an example (detection information 321) of detection information acquired by the detection information acquisition unit 31. The detection information 321 is information in which biometric information (feature amount) of the traveler is associated with a time and a place at which a face image or the like, from which the biometric information originates, is acquired, and payment data including an amount paid at that time and at that place. For example, the detection information 321 is generated by the detection terminal 352 including a camera for photographing a face of a traveler and capable of acquiring payment details of the traveler.

The search unit 32 acquires the detection information from the detection information acquisition unit 31. When acquiring the detection information, the search unit 32 retrieves personal information corresponding to the biometric information included in the detection information, referring to the first database 310. For example, the search unit 32 searches the first database 310 in a one-to-N collation manner. The search unit 32 outputs the retrieved personal information to the behavior information generation unit 33.

The behavior information generation unit 33 acquires the personal information retrieved by the search unit 32. The behavior information generation unit 33 generates behavior information in which the personal information retrieved by the search unit 32 is associated with the time, the place, and the payment data included in the detection information. The behavior information generation unit 33 accumulates the generated behavior information in the second database 320. FIG. 19 is a conceptual diagram illustrating an example (behavior information 331) of behavior information generated by the behavior information generation unit 33. The behavior information 331 is information in which personal information of a traveler is associated with a time and a place at which the traveler visited a tourism spot or the like, and payment data including an amount paid at that time and at that place.

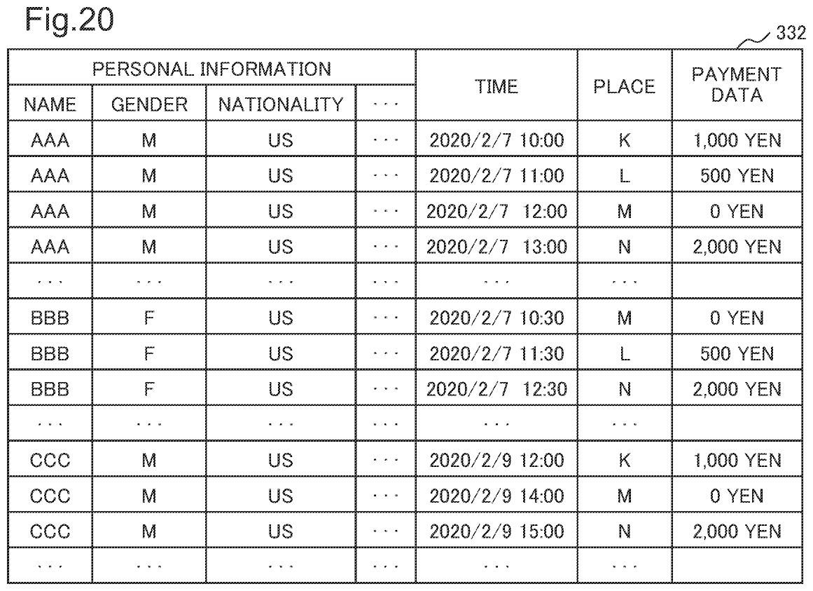

FIG. 20 is a table illustrating an example (behavior information 332) of behavior information accumulated in the second database 320 by the behavior information generation unit 33. The behavior information 332 includes information in which personal information including names, genders, nationalities, etc. of a plurality of travelers is associated with times and places at which the plurality of travelers were detected at tourism spots. Concerning a traveler whose name is AAA, the gender is male M and the nationality is the United States US. On Feb. 7, 2020, AAA was detected at facility K at 10:00, at facility L at 11:00, at facility M at 12:00, and at facility N at 13:00. In the example of FIG. 20, the facilities involve payment (including 0 yen) for a store bill, an entrance fee, a hospital bill, and the like, in a store, a shrine or a temple, a museum, a park, and the like.

For example, the behavior information generation unit 33 generates behavior history information including a behavior history of a traveler by using the behavior information accumulated in the second database 320. The behavior history information is information in which personal information of a traveler is associated with a behavior history of the traveler and an amount paid by the traveler in the behavior history. For example, the behavior information generation unit 33 generates behavior history information for each traveler. For example, the behavior information generation unit 33 generates behavior history information at a certain timing such as a timing when a request is received from a user who uses the second database 320, a timing when a date changes, or a timing when a traveler goes home.

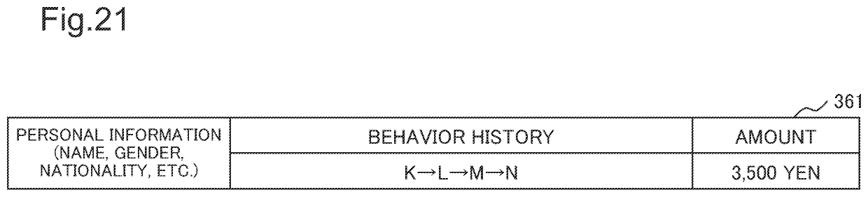

FIG. 21 illustrates an example (behavior history information 361) of a behavior history generated by the behavior information generation unit 33 using the behavior information accumulated in the second database 320. For example, the behavior information generation unit 33 determines that “AAA made payment in facilities K, L, M, and N in this order on Feb. 7, 2020”, referring to times included in the behavior information 332 of FIG. 20 Based on the determination result, the behavior information generation unit 33 generates behavior history information 361 in which the tourism spots visited by the traveler are listed in time-series order, together with an amount paid by the traveler that is calculated in the behavior history. The behavior information generation unit 33 generates the behavior history information 361 including personal information of a traveler, a behavior history of the traveler, and an amount paid by the traveler in the behavior history. The amount paid by the traveler may be a payment history for each of the behaviors included in the behavior history, or may be a total payment amount for all of the behaviors included in the behavior history.

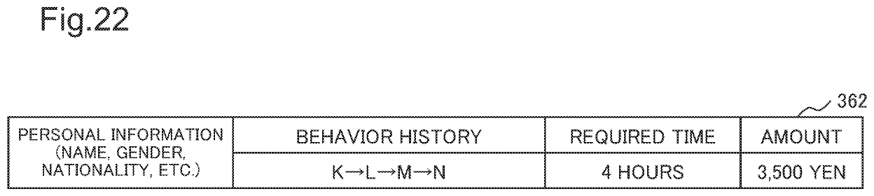

FIG. 22 illustrates another example (behavior history information 362) of a behavior history generated by the behavior information generation unit 33 using the behavior information accumulated in the second database 320. For example, the behavior information generation unit 33 determines that “AAA made payment in facilities K, L, M, and N in this order on Feb. 7, 2020”, referring to times included in the behavior information 332 of FIG. 20 In addition, the behavior information generation unit 33 calculates an amount paid by the traveler in the behavior history. Based on the determination result, the behavior information generation unit 33 generates behavior history information 362 in which the tourism spots visited by the traveler are listed in time-series order, together with an amount paid by the traveler that is calculated in the behavior history. The behavior information generation unit 33 generates the behavior history information 362 including personal information of a traveler, a behavior history of the traveler, a required time for the behavior history, and an amount paid by the traveler in the behavior history.

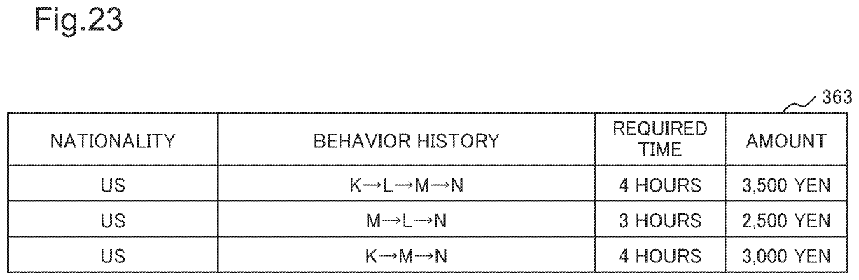

FIG. 23 is a table illustrating an example (behavior history information 363) of behavior history information in which the behavior history information generated based on the behavior information (behavior information 332) accumulated in the second database 320 is sorted by nationality, which is attribute data. The behavior history information 363 is an example in which behavior history information of travelers whose nationality is US is sorted out among the attribute data included in the personal information.

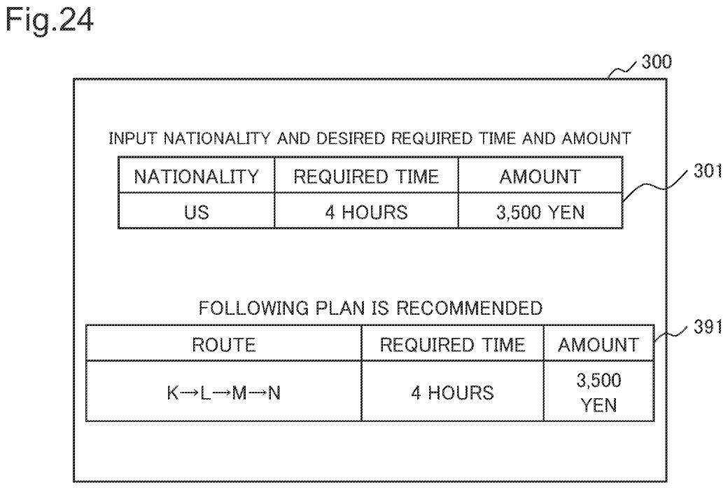

FIG. 24 is a conceptual diagram illustrating an example (recommendation information 391) of recommendation information generated by the behavior information generation unit 33. FIG. 24 is an example in which the recommendation information 391 based on input information 301 is displayed on a screen of a display device 300. For example, in a field for inputting the input conditions 301, a nationality of a traveler, a desired required time, and a desired fee are input. For example, the information generation device 30 selects the recommendation information 391 including a behavior history that satisfies the input desired fee among behavior histories taken by travelers having the input nationality in a time zone including the input desired required time. In the example of FIG. 24, the information generation device 30 presents the recommendation information 391 including a route to travel around facilities K, L, M, and N in this order, in which the required time is 4 hours and the amount is 3500 yen, according to the input conditions 301. The required time and the amount received by the information generation device 30 may not be numerical values desired by the traveler. For example, the information generation device 30 may accept such a numerical range that a required time is less than/equal to or less than 4 hours and an amount is less than/equal to or less than 3500 yen.

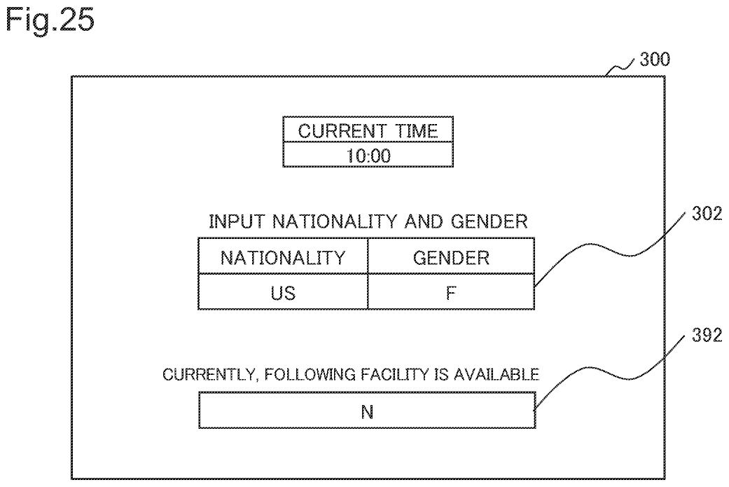

FIG. 25 is a conceptual diagram illustrating another example (recommendation information 392) of recommendation information generated by the behavior information generation unit 33. FIG. 25 is an example in which the recommendation information 392 based on input information 302 is displayed on the screen of the display device 300. For example, in a field for inputting input conditions 302, attributes of a traveler such as nationality and gender are input. The information generation device 30 causes the display device 300 to display the recommendation information 392 based on the input attributes such as nationality and gender. In the example of FIG. 25, the information generation device 30 presents an unoccupied spot (facility N) as the recommendation information 392 in consideration of how crowded the facility is currently.

As described above, in one aspect of the present example embodiment, the detection information includes payment data according to an amount paid by a traveler in facilities included in the tourism spot. The behavior information generation unit generates behavior history information in which personal information of a traveler and a behavior history of the traveler, in which behavior information is listed in time series, are associated with payment data of the traveler who has behaved in the behavior history.

For example, the behavior information generation unit generates behavior history information in which the personal information of the traveler and the behavior history of the traveler are associated with an amount obtained by adding up the payment data of the traveler who has behaved in the behavior history. For example, the behavior information generation unit generates behavior history information in which the personal information of the traveler and the behavior history of the traveler are associated with a required time when the traveler has behaved in the behavior history and an amount obtained by adding up the payment data of the traveler who has behaved in the behavior history. For example, the behavior information generation unit generates recommendation information including the behavior history that satisfies at least one of attribute data of the traveler, a required time desired by the traveler, and an amount desired by the traveler.

According to the present example embodiment, it is possible to estimate a cost to be spent in each of the facilities by accumulating the payment data of the traveler for each of facilities of the tourism spot. Therefore, it is possible to present a rough estimated amount at the time of recommending a course for traveling around a plurality of facilities to a traveler. In addition, by using the accumulated payment data, it is possible to generate statistical data in which personal consumption in tourism spots and facilities is accurately reflected.

The information generation system according to the present example embodiment can be applied to generate behavior history information about a traveler who has visited a retail store, as well as a traveler who has visited a facility in a tourism spot. For example, the information generation system according to the present example embodiment can be applied for the purpose of generating behavior history information including payment data of a foreign traveler who has visited a retail store such as a duty-free shop. In addition, by using the technique according to the present example embodiment, it is possible to achieve a payment system based on face authentication using data on a face of a traveler. For example, the payment system based on face authentication can be achieved by using face data obtained by photographing a face of a traveler who has visited a retail store through a detection terminal installed in the store, the detection terminal including a POS terminal capable of photographing a face.

### Fourth Example Embodiment

Next, an information generation device according to a fourth example embodiment will be described with reference to the drawings. The information generation device according to the present example embodiment has a more simplified configuration than the information generation devices according to the first to third example embodiments. In the present example embodiment, a time is not included in the detection information.

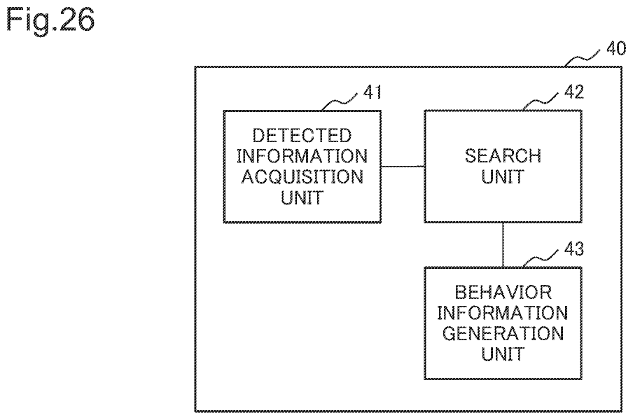

FIG. 26 is a block diagram illustrating an example of a configuration of the information generation device 40 according to the present example embodiment. The information generation device 40 includes a detection information acquisition unit 41, a search unit 42, and a behavior information generation unit 43.

The information generation device 40 is connected to a first database (not illustrated) and a second database (not illustrated).

The detection information acquisition unit 41 acquires detection information in which biometric information (e.g., biometric information of a person) detected at a tourism spot is associated with a place at which the biometric information is detected. The search unit 42 searches a first database (not illustrated) in which identification information, in which personal information of the person is associated with the biometric information, is accumulated to identify the person from which the detection information originates using the biometric information included in the detection information. The behavior information generation unit 43 generates behavior information in which the personal information of the person from which the detection information originates is associated with the place at which the biometric information of the person from which the detection information originates is detected, and records the generated behavior information in a second database (not illustrated).

According to the present example embodiment, it is possible to track a person based on biometric information detected at a tourism spot, and accordingly, it is possible to generate accurate statistical data about tourists. For example, a history of places visited by US tourists can be taken as a behavior history that the US tourists have.

(Hardware)

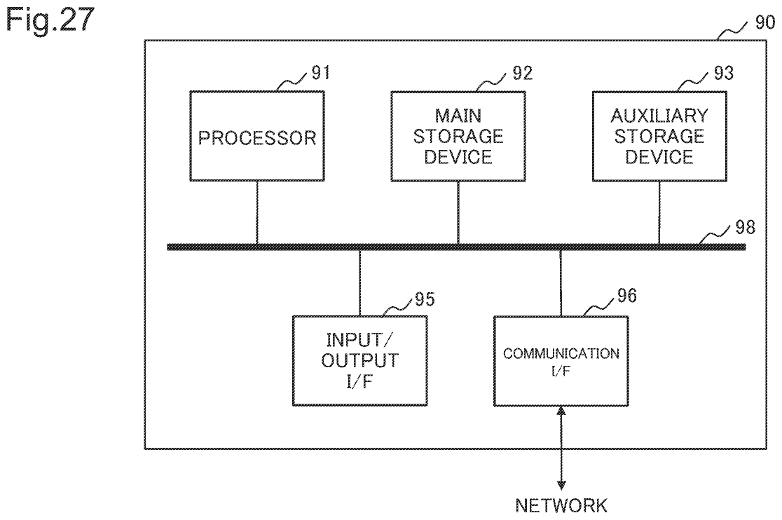

Here, a hardware configuration for executing the processing of the information generation device according to each of the above-described example embodiments will be described using an information processing apparatus 90 illustrated in FIG. 27 as an example. Note that the information processing apparatus 90 of FIG. 27 is an example of the configuration for executing the processing of the information generation device according to each of the above-described example embodiments, and does not limit the scope of the present invention.

As illustrated in FIG. 27, the information processing apparatus 90 includes a processor 91, a main storage device 92, an auxiliary storage device 93, an input/output interface 95, and a communication interface 96. In FIG. 27, an interface is abbreviated as an I/F. The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 develops a program stored in the auxiliary storage device 93 or the like in the main storage device 92 and executes the developed program. In the present example embodiment, a software program installed in the information processing apparatus 90 may be used. The processor 91 executes the processing of the information generation device according to the present example embodiment.

The main storage device 92 has an area in which a program is developed. The main storage device 92 may be a volatile memory such as a dynamic random access memory (DRAM). In addition, a nonvolatile memory such as a magnetoresistive random access memory (MRAM) may be included or added as the main storage device 92.

The auxiliary storage device 93 stores various data. The auxiliary storage device 93 includes a local disk such as a hard disk or a flash memory. Note that various data may be stored in the main storage device 92, and the auxiliary storage device 93 may be omitted.

The input/output interface 95 is an interface for connecting the information processing apparatus 90 and a peripheral device to each other. The communication interface 96 is an interface for connection to an external system or device through a network such as the Internet or an intranet in accordance with a standard or a specification. The input/output interface 95 and the communication interface 96 may be constituted by a single interface connected to an external device.

The information processing apparatus 90 may be configured to allow an input device such as a keyboard, a mouse, or a touch panel to be connected thereto if necessary. These input devices are used to input information and settings. In a case where a touch panel is used as an input device, a display screen of a display device may also serve as an interface of the input device. Data communication between the processor 91 and the input device may be mediated by the input/output interface 95.

Furthermore, the information processing apparatus 90 may include a display device for displaying information. In a case where the information processing apparatus 90 may include a display device, the information processing apparatus 90 preferably includes a display control device (not illustrated) for controlling the display of the display device. The display device may be connected to the information processing apparatus 90 via the input/output interface 95.

An example of the hardware configuration for enabling the processing of the information generation device according to each of the above-described example embodiments has been described above. Note that the hardware configuration of FIG. 27 is an example of a hardware configuration for executing the arithmetic processing of the information generation device according to each of the above-described example embodiments and does not limit the scope of the present invention. In addition, a program for causing a computer to execute the processing of the information generation device according to each of the above-described example embodiments also falls within the scope of the present invention. Furthermore, a recording medium recording the program according to each of the above-described example embodiments also falls within the scope of the present invention. The recording medium can be achieved by, for example, an optical recording medium such as a compact disc (CD) or a digital versatile disc (DVD). Alternatively, the recording medium may be achieved by a semiconductor recording medium such as a universal serial bus (USB) memory or a secure digital (SD) card, a magnetic recording medium such as a flexible disk, or another type of recording medium. In a case where a program executed by the processor is recorded in a recording medium, the recording medium corresponds to a program recording medium.

The components of the information generation device according to each of the above-described example embodiments can be freely combined. In addition, components of the information generation device according to each of the above-described example embodiments may be achieved by software or by a circuit.

Although the present invention has been described with reference to the example embodiments above, the present invention is not limited to the above-described example embodiments. It will be understood by those skilled in the art that various modifications may be made to the configuration of the present invention within the scope of the present invention.

Some or all of the above-described example embodiments may be described as in the following supplementary notes but are not limited to the following supplementary notes.

(Supplementary Note 1)

An information generation device including:
a detection information acquisition unit that acquires detection information in which biometric information detected at a tourism spot is associated with a place at which the biometric information is detected;
a search unit that searches a first database in which identification information, in which personal information of a person is associated with the biometric information, is accumulated to identify the personal information of the person from which the detection information originates using the biometric information included in the detection information; and
a behavior information generation unit that generates behavior information in which the personal information of the person from which the detection information originates is associated with the place at which the biometric information of the person from which the detection information originates is detected, and records the generated behavior information in a second database.

(Supplementary Note 2)

The information generation device according to Supplementary Note 1, in which the personal information includes
attribute data on at least one of nationality and gender of the person.

(Supplementary Note 3)

The information generation device according to Supplementary Note 2, in which the biometric information extracted from face data generated by photographing a face of the person, the nationality of the person, and the gender of the person are registered in the first database in association with each other.

(Supplementary Note 4)

The information generation device according to Supplementary Note 3, in which the nationality and the gender of the person read from a passport of the person when the face of the person is photographed are registered in the first database in association with the biometric information.

(Supplementary Note 5)

The information generation device according to any one of Supplementary Notes 2 to 4, further including
a search condition acquisition unit that acquires a search condition for searching the second database,
in which the behavior information generation unit searches the second database according to the search condition, and generates rank information with respect to places included in the behavior information satisfying the search condition.

(Supplementary Note 6)

The information generation device according to Supplementary Note 5, in which the detection information acquisition unit acquires the detection information including a time at which the biometric information is detected, and
the behavior information generation unit generates the behavior information in which the personal information of the person from which the detection information originates is associated with the place and the time at which the biometric information of the person from which the detection information originates is detected, and records the generated behavior information in the second database.

(Supplementary Note 7)

The information generation device according to Supplementary Note 6, in which the behavior information generation unit searches the second database based on at least one of the attribute data and the time included in the behavior information, and generates the rank information with respect to places included in retrieved behavior information.

(Supplementary Note 8)

The information generation device according to Supplementary Note 6 or 7, in which based on the rank information, the behavior information generation unit generates recommendation information for recommending at least one among the places included in the behavior information satisfying the search condition.

(Supplementary Note 9)

The information generation device according to any one of Supplementary Notes 2 to 8, in which the behavior information generation unit generates behavior history information in which a behavior history, in which the behavior information of the person is listed in time series, is associated with the personal information.

(Supplementary Note 10)

The information generation device according to Supplementary Note 9, in which the behavior information generation unit sorts the behavior history information using at least one piece of the attribute data as a key.

(Supplementary Note 11)

The information generation device according to any one of Supplementary Notes 1 to 10, in which the detection information includes
payment data according to an amount paid by the person in facilities included in the tourism spot, and
the behavior information generation unit generates
the behavior history information in which the personal information of the person and the behavior history of the person, in which the behavior information is listed in time series, are associated with the payment data of the person who has behaved in the behavior history.

(Supplementary Note 12)

The information generation device according to Supplementary Note 11, in which the behavior information generation unit generates
the behavior history information in which the personal information of the person and the behavior history of the person are associated with an amount obtained by adding up the payment data of the person who has behaved in the behavior history.

(Supplementary Note 13)

The information generation device according to Supplementary Note 11, in which the behavior information generation unit generates
the behavior history information in which the personal information of the person and the behavior history of the person are associated with a required time when the person has behaved in the behavior history and an amount obtained by adding up the payment data of the person who has behaved in the behavior history.

(Supplementary Note 14)

The information generation device according to Supplementary Note 13, in which the behavior information generation unit generates recommendation information including the behavior history that satisfies at least one of attribute data of the person, a required time desired by the person, and an amount desired by the person.

(Supplementary Note 15)

An information generation system including:
the information generation device according to any one of Supplementary Notes 1 to 14; and
the second database.

(Supplementary Note 16)

The information generation system according to Supplementary Note 15, further including a detection information generation device that detects the biometric information of the person, generates the detection information by associating the place and the time at which the biometric information of the person is detected with the biometric information of the person, and outputs the generated detection information to the information generation device.

(Supplementary Note 17)

The information generation system according to Supplementary Note 15 or 16, further including the first database.

(Supplementary Note 18)

The information generation system according to any one of Supplementary Notes 15 to 17, further including an identification information generation device that acquires the personal information and the biometric information of the person, generates the identification information by associating the personal information and the biometric information of the person with each other, and registers the generated identification information in the first database.

(Supplementary Note 19)

An information generation method performed by a computer, including:
acquiring detection information in which biometric information detected at a tourism spot is associated with a place at which the biometric information is detected;
searching a first database in which identification information, in which personal information of a person is associated with the biometric information, is accumulated to identify the person from which the detection information originates using the biometric information included in the detection information; and
generating behavior information in which the personal information of the person from which the detection information originates is associated with the place at which the biometric information of the person from which the detection information originates is detected, and recording the generated behavior information in a second database.

(Supplementary Note 20)

A program for causing a computer to execute processing of:
acquiring detection information in which biometric information detected at a tourism spot is associated with a place at which the biometric information is detected;
searching a first database in which identification information, in which personal information of a person is associated with the biometric information, is accumulated to identify the person from which the detection information originates using the biometric information included in the detection information; and
generating behavior information in which the personal information of the person from which the detection information originates is associated with the place at which the biometric information of the person from which the detection information originates is detected, and recording the generated behavior information in a second database.

### REFERENCE SIGNS LIST

1, 2, 3 Information generation system
10, 20, 30, 40 Information generation device
11, 21, 31, 41 Detection information acquisition unit
12, 22, 32, 42 Search unit
13, 23, 33, 43 Behavior information generation unit
27 Search condition acquisition unit
110, 210, 310 First database
120, 220, 320 Second database

1. An information generation device comprising,
a memory configured to store instructions; and
at least one processor configured to execute the instructions to perform:
accepting an input search conditions including a required time and a payment;
generating a tourist route in accordance with the search conditions by referring to a database storing information representing a required time and fee for each tourism spot; and
presenting recommendation information including a tourist route plan, required time for the tourist route plan, and total fee about the tourist route plan.

2. The information generation device according to claim 1, wherein the at least one processor is configured to execute the instructions to perform:
acquiring (i) payment data including an amount paid from a payment system based on face authentication, and (ii) biometrics information of a person who paid when the person paid at a facility in a tourism spot;
identifying the person who paid with the acquired biometrics information, referring to a database soring personal information of tourists; and
generating behavior history information of the person who paid by correlating information indicating a place of the tourism spot, the payment data, and personal information of the person.

3. The information generation device according to claim 2, wherein the personal information includes attribute data on at least one of nationality and gender of the person.

4. The information generation device according to claim 3, wherein the biometric information extracted from face data generated by photographing a face of the person, the nationality of the person, and the gender of the person are registered in the first database in association with each other.

5. The information generation device according to claim 4, wherein the nationality and the gender of the person read from a passport of the person when the face of the person is photographed are registered in the first database in association with the biometric information.

6. An information generation method performed by a computer, comprising:
accepting an input search conditions including a required time and a payment;
generating a tourist route in accordance with the search conditions by referring to a database storing information representing a required time and fee for each tourism spot; and
presenting recommendation information including a tourist route plan, required time for the tourist route plan, and total fee about the tourist route plan.

7. The information generation method according to claim 6, wherein the information generation method comprises:
acquiring (i) payment data including an amount paid from a payment system based on face authentication, and (ii) biometrics information of a person who paid when the person paid at a facility in a tourism spot;
identifying the person who paid with the acquired biometrics information, referring to a database soring personal information of tourists; and
generating behavior history information of the person who paid by correlating information indicating a place of the tourism spot, the payment data, and personal information of the person.

8. The information generation device according to claim 7, wherein the personal information includes attribute data on at least one of nationality and gender of the person.

9. The information generation device according to claim 8, wherein the biometric information extracted from face data generated by photographing a face of the person, the nationality of the person, and the gender of the person are registered in the first database in association with each other.

10. The information generation device according to claim 9, wherein the nationality and the gender of the person read from a passport of the person when the face of the person is photographed are registered in the first database in association with the biometric information.

11. A non-transitory recording medium recording a program for causing a computer to execute processing of:
accepting an input search conditions including a required time and a payment;
generating a tourist route in accordance with the search conditions by referring to a database storing information representing a required time and fee for each tourism spot; and
presenting recommendation information including a tourist route plan, required time for the tourist route plan, and total fee about the tourist route plan.

12. The non-transitory recording medium according to claim 11, wherein the program causes a computer to execute processing of:
acquiring (i) payment data including an amount paid from a payment system based on face authentication, and (ii) biometrics information of a person who paid when the person paid at a facility in a tourism spot;
identifying the person who paid with the acquired biometrics information, referring to a database soring personal information of tourists; and
generating behavior history information of the person who paid by correlating information indicating a place of the tourism spot, the payment data, and personal information of the person.

13. The non-transitory recording medium according to claim 12, wherein the personal information includes attribute data on at least one of nationality and gender of the person.

14. The non-transitory recording medium according to claim 13, wherein the biometric information extracted from face data generated by photographing a face of the person, the nationality of the person, and the gender of the person are registered in the first database in association with each other.

15. The non-transitory recording medium according to claim 14, wherein the nationality and the gender of the person read from a passport of the person when the face of the person is photographed are registered in the first database in association with the biometric information.
